(19) United States
(12) Patent Application Publication
(10) Pub. No.: US 2026/0188017 A1
(43) Pub. Date: Jul. 2, 2026

(54) SYSTEM, APPARATUS, AND METHOD FOR MONITORING INSTALLED UTILITY INFRASTRUCTURE

(71) Applicant: UBICQUIA, INC., FORT LAUDERDALE, FL (US)

(72) Inventors: Ian B. Aaron, Fort Lauderdale, FL (US); Claudio Santiago Ribeiro, Evanston, IL (US)

(21) Appl. No.: 19/437,903

(22) Filed: Dec. 31, 2025

Related U.S. Application Data
(60) Provisional application No. 63/740,969, filed on Dec. 31, 2024.
(60) Provisional application No. 63/951,450, filed on Dec. 30, 2025.

(51) Int. Cl. G06V 20/52; G06V 20/10; H04N 7/18; H04N 23/65; H04N 23/90

(52) U.S. Cl. CPC G06V 20/52; G06V 20/188; H04N 7/181; H04N 23/65; H04N 23/90

(57) ABSTRACT

An apparatus for monitoring installed utility infrastructure, such as electrical grid assets, includes one or more cameras, memory, and a processor. The camera (or each camera where multiple are used) is configured to capture images from one or more monitored areas in proximity to the utility infrastructure and/or its components. The memory stores image data for the captured images (at least temporarily). The processor is operable to retrieve the image data from memory, analyze the image data to determine whether an event related to an infrastructure component of the one or more utility infrastructure components is occurring or has occurred in the at least one monitored area, and when an event is detected, communicate an alert notification for the event. The apparatus may be self-powered through use of a solar cell or panel, a battery, or, more preferably, power inductively coupled from a power line proximate the monitored utility infrastructure.

### CROSS-REFERENCE TO RELATED APPLICATIONS

The present application claims the benefit of and priority upon U.S. Provisional Ser. No. 63/740,969 , which was filed on Dec. 31, 2024, and is incorporated herein by this reference as if fully set forth herein. The present application also claims the benefit of and priority upon U.S. Provisional Ser. No. 63/951,450 , which was filed on Dec. 30, 2025, and is incorporated herein by this reference as if fully set forth herein

### TECHNICAL FIELD

The present disclosure relates generally to electrical grid management and, more particularly, to a system, apparatus, and method for monitoring installed utility infrastructure.

### BACKGROUND

Various types of electrical utility infrastructure, such as power lines, utility poles, transformers, certain electrical power generation equipment (e.g., wind turbines or solar panels), streetlights, and many other devices, machines, and systems, are installed in outdoor locations and are subject to environmental and other conditions. For example, power lines, utility poles, streetlights, and transformers may be negatively affected by moderate or extreme weather events, overgrowth of nearby vegetation, animal encroachment, and so forth. Therefore, such infrastructure must be periodically checked to ensure it is operating properly and can continue to do so.

However, periodic visits to utility infrastructure installation sites by utility employees or contractors are costly, especially when the visits are not actually necessary (e.g., because the visits do not require any maintenance to be performed at the visited installation sites). Such visits typically require maintenance crews and appropriate vehicles (e.g., bucket trucks) and equipment in case maintenance of the installed utility infrastructure does need to be performed during one or more of the visits.

### SUMMARY

In accordance with some embodiments of the present disclosure, a grid asset monitoring apparatus includes at least one camera, memory, and a processor. The camera (or each camera, where multiple cameras are included) is configured to capture images of at least one monitored area in proximity to one or more installed utility infrastructure components. The camera has at least one field of view covering the at least one monitored area. The images may be captured continuously, on demand through commands sent from a remote computing device, or at scheduled intervals. The memory is configured to store processor-readable operating instructions and at least temporarily store image data for the images captured by the camera or cameras. The processor is operable in accordance with the processor-readable operating instructions to retrieve the image data from the memory, analyze the image data to determine whether an event related to an infrastructure component of the one or more utility infrastructure components is occurring or has occurred in a monitored area, and when an event is detected, communicate an alert for the event (e.g., to a remote computing device). For example, the processor may use machine learning, image recognition, or computer vision artificial intelligence (AI) models or algorithms to analyze the captured images to detect vegetation encroachment on or toward power lines over time, sparking or fire on power lines or near a utility pole due to a lightning strike or a wildfire, flooding near a transformer, or animal or human encroachment near a transformer or utility pole. The grid asset monitoring apparatus may be secured to the utility infrastructure component being monitored or to another structure near the utility infrastructure component being monitored (e.g., secured to a utility pole to monitor another utility pole, a transformer mounted to the other utility pole, and/or power lines, for example).

In accordance with alternative embodiments of the present disclosure, the grid asset monitoring apparatus may include a wireless transceiver (e.g., a cellular modem) operably coupled to the processor. In such cases, the processor may communicate the alert through the wireless transceiver to a remote computing device.

In accordance with further alternative embodiments of the present disclosure, the grid asset monitoring apparatus may include means, such as a power harvesting assembly, for inductively coupling electromagnetic energy from a power cable supported by one or more utility infrastructure components and means, such as an alternating current (AC)-to-direct current (DC) converter, rectifier, or regulator, for converting the electromagnetic energy to DC power for use by the camera(s), the memory, the processor, and any other components of the grid asset monitoring apparatus that require DC power to operate.

In accordance with further alternative embodiments of the present disclosure, the grid asset monitoring apparatus may include a plurality of cameras. In such embodiments, each camera of the plurality of cameras has at least one field of view covering one or more monitored areas in proximity to one or more infrastructure components.

In accordance with other alternative embodiments of the present disclosure, a grid asset monitoring system includes a plurality of grid asset monitoring devices positioned so as to permit monitoring of a plurality of monitored areas in proximity to a plurality of utility infrastructure components and a remote computing device in communication with the grid asset monitoring devices. In such embodiments, each grid asset monitoring device monitors at least one monitored area of the plurality of monitored areas and includes at least one camera, memory, a processor, and a wireless transceiver. The camera (or each camera, where multiple cameras are included) is configured to capture images of at least one monitored area in proximity to one or more installed utility infrastructure components. The camera has at least one field of view covering the at least one monitored area. The images may be captured continuously, on demand through commands sent from the remote computing device, or at scheduled intervals. The memory is configured to store processor-readable operating instructions and at least temporarily store image data for the images captured by the camera or cameras. The processor is operable in accordance with the processor-readable operating instructions to retrieve the image data from the memory, analyze the image data to determine whether an event related to an infrastructure component of the one or more utility infrastructure components is occurring or has occurred in a monitored area, and when an event is detected, communicate an alert for the event to the remote computing device via the wireless transceiver. The remote computing device is operable to receive alerts from the grid asset monitoring devices and present alert notifications to an operator of the utility infrastructure components through an asset management and control panel display (e.g., a multilayer dashboard) allocated to the operator and available as part of a web application accessible by the operator through a web browser or downloaded client application.

In accordance with other alternative embodiments of the present disclosure, each grid asset monitoring device of the grid asset monitoring system may include means, such as a power harvesting assembly, for inductively coupling electromagnetic energy from a power cable supported by one or more utility infrastructure components and means, such as an AC-to-DC converter, rectifier, or regulator, for converting the electromagnetic energy to DC power for use by the camera(s), the memory, the processor, the wireless transceiver, and any other components of the grid asset monitoring apparatus that require DC power to operate.

In accordance with other alternative embodiments of the present disclosure, a method for monitoring one or more installed utility infrastructure components is executable by a processor fixedly positioned in proximity to the one or more installed utility infrastructure components (e.g., secured to one of the utility infrastructure components or a structure in proximity to the one or more utility infrastructure components). According to the method, the processor retrieves, from a memory, image data for images captured by at least one camera, where the camera (or each camera, where multiple cameras are included) has at least one field of view covering at least one monitored area in proximity to the one or more installed utility infrastructure components. The processor analyzes the image data to determine whether an event related to an installed infrastructure component is occurring or has occurred in a monitored area. When the processor detects an event, the processor communicates an alert (e.g., via a wireless transceiver) to a remote computing device to facilitate presentation of an alert notification to an operator of the installed infrastructure component or components.

Although the present disclosure illustrates and describes one or more exemplary systems, apparatus, and methods for monitoring utility infrastructure installed at an installation location, the disclosure is not intended to be limited to the specific disclosed embodiments because various modifications and structural changes may be made therein without departing from the spirit of the disclosure and while remaining within the scope and range of equivalents of the claims. Additionally, well-known elements of disclosed devices, systems, or servers will not be described in detail or will be omitted so as not to obscure the relevant details of the disclosure.

Features that are considered characteristic of the invention are set forth in the appended claims. As required, detailed embodiments of the disclosed system, apparatus, and method are set forth herein; however, it is to be understood that the disclosed embodiments are merely exemplary. Therefore, specific structural and functional details disclosed herein are not to be interpreted as limiting, but merely as a basis for the claims and as a representative basis for teaching one of ordinary skill in the art to variously employ the claimed invention in appropriately detailed structures. Further, the terms and phrases used herein are not intended to be limiting; but rather, to provide an understandable description of the disclosure. While the specification concludes with claims defining the features of the invention, it is believed that the present disclosure will be better understood from a consideration of the following description in conjunction with the drawing figures, in which like reference numerals refer to similar elements or items. The figures of the drawings are not drawn to scale.

The terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, mean “comprising” or “including, but not limited to” (i.e., open language). The term “coupled,” as used herein, is defined as connected, although not necessarily directly and not necessarily mechanically. The term “providing” is defined herein in its broadest sense (e.g., bringing/coming into physical existence, making available, and/or supplying to someone or something, in whole or in multiple parts at once or over a period of time).

As used in this description, unless otherwise specified, azimuth or positional relationships indicated by terms such as “up,” “down,” “left,” “right,” “inside,” “outside,” “front,” “back,” “head,” “tail,” and so on are azimuth or positional relationships based on the drawings, which are only to facilitate description of the embodiments of the present disclosure and simplify the description, but not to indicate or imply that the devices or components must have a specific azimuth or be constructed or operated in the specific azimuth, which thus should not be understood as a limitation to the embodiments of the present disclosure. Furthermore, terms such as “first,” “second,” “third” and so on are only used for identifying purposes and are not to be construed as indicating or implying relative importance or order.

As used in this description, unless otherwise clearly defined and limited, terms such as “installed,” “coupled,” “connected,” and the like should be broadly interpreted to mean being done so in a fixed, detachable, integral, mechanical, electrical, electromechanical, direct, or indirect (e.g., via an intermediate medium) manner. As used herein, the terms “about” or “approximately” apply to all numeric values, whether or not explicitly indicated. These terms generally refer to a range of numbers that one of skill in the art would consider equivalent to the recited values (i.e., having the same function or result). In many instances, these terms may include numbers that are rounded to the nearest significant figure. In this document, the term “longitudinal” should be understood to mean in a direction corresponding to an elongated direction of a device or element. Those skilled in the art can readily understand the meanings of the above-mentioned terms in the context of the disclosed exemplary embodiments of the present disclosure.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present disclosure.

FIG. 1 illustrates an exemplary but simplified grid asset monitoring system, in accordance with some embodiments of the present disclosure.

FIG. 2 illustrates an exemplary block diagram of a grid asset monitoring apparatus for used in the systems of FIG. 1 and FIG. 3, in accordance with some embodiments of the present disclosure.

FIG. 3 illustrates an environmental view of an exemplary power distribution network with an associated grid asset monitoring system, in accordance with some embodiments of the present disclosure.

FIG. 4 shows a logic flow diagram of steps executed by a processor of a grid asset monitoring apparatus, in accordance with some embodiments of the present disclosure.

FIG. 5 illustrates a cross-sectional view of an exemplary power harvesting assembly for use with the grid asset monitoring apparatus shown in FIGS. 1-3, in accordance with some embodiments of the present disclosure.

FIG. 5A shows a partial perspective view of an exemplary inductive wrap wrapped around a power line as adapted for use with a power harvesting assembly, in accordance with some embodiments of the present disclosure.

FIG. 5B shows a partial perspective view of the exemplary inductive wrap of FIG. 5A wrapped around a power line and placed in an open housing, in accordance with some embodiments of the present disclosure.

### DETAILED DESCRIPTION

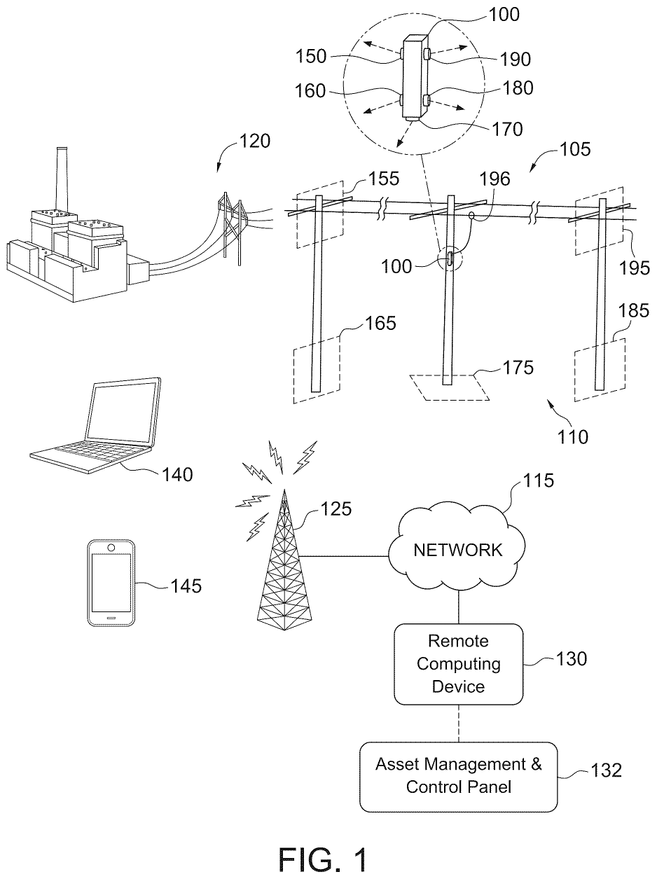

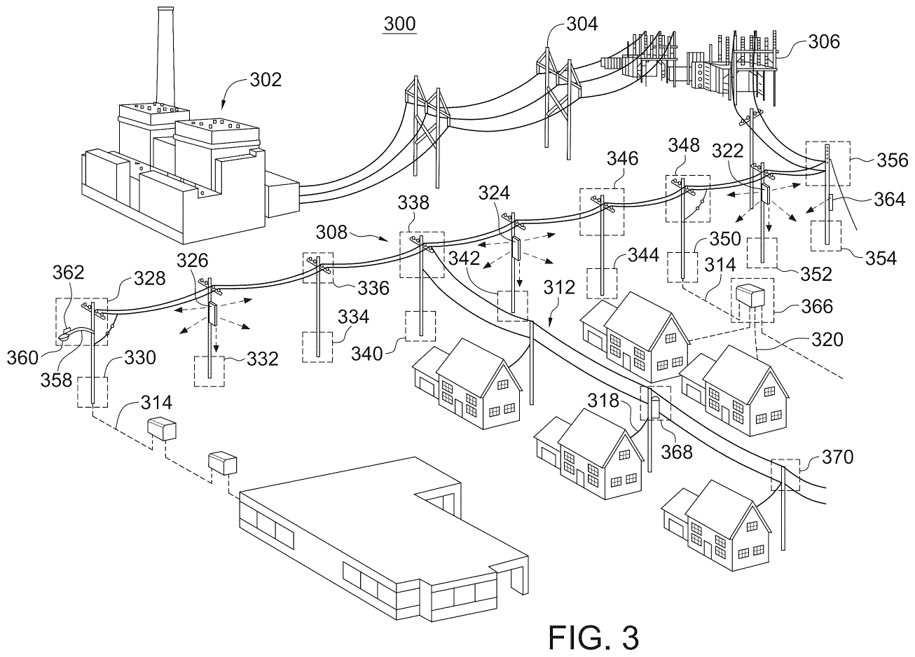

FIG. 1 shows a grid asset monitoring apparatus 100 which is configured for monitoring utility infrastructure 105 in the vicinity of an installation location 110, in accordance with some embodiments. The grid asset monitoring apparatus 100 may be communicatively coupled to a remote computing device 130 (e.g., a standalone server or server instance on a cloud-based service, such as Amazon Web Service or Google Cloud Platform) over a wireless network 125 and the internet 115, such as through a secure segmented virtual private network (VPN). The entity managing the monitoring apparatus 100 (or a group of monitoring apparatus as illustrated in exemplary form in FIG. 3) may receive data from the grid asset monitoring apparatus 100 and configure settings for the apparatus 100, including camera settings, through an asset management and control panel display 132 that is accessible by a computer terminal 140 or a mobile device 145 (e.g., a smartphone or tablet computer) through a web-based application running on the remote computing device/system 130 or through a mobile client application in communication with the web-based application.

The wireless network 125 may include any type of wireless network (public or private) that is capable of sending and receiving wireless signals. For example, the wireless network 125 may be or include a wireless telecommunications network, a cellular telephone network, a Time Division Multiple Access (TDMA) network, a Code Division Multiple Access (CDMA) network, a Third-Fifth Generation (3G, 4G or 5G) network, a satellite communications network, and other like communications systems. The internet 115 may include more than one network and may include a plurality of different types of networks including wireless and/or fiber. In operation, the grid asset monitoring apparatus 100 can communicate with the network 115 and devices on the network 115, such as the remote computing device/system 130, by sending and receiving wireless signals via the wireless network 125, for example.

The exemplary grid asset monitoring apparatus 100 includes a plurality of cameras (five cameras 150, 160, 170, 180, 190 shown for illustration purposes) with each camera 150, 160, 170, 180, 190 having an associated field of view to cover a respective monitored area 155, 165, 175, 185, 195 (five monitored areas shown for illustration purposes). Depending on the imaging coverage needed at a particular installation site, the grid asset monitoring apparatus 100 may include one or more cameras.

In an exemplary embodiment, in use during installation or later, for example, when capturing images using the grid asset monitoring apparatus 100 (using one or more of the respective cameras), the grid asset monitoring apparatus 100 can provide: (i) estimated or actual geocoordinates of the captured images of a particular monitored area; and (ii) the actual geocoordinates of the camera, from the computing device's 100 GPS receiver.

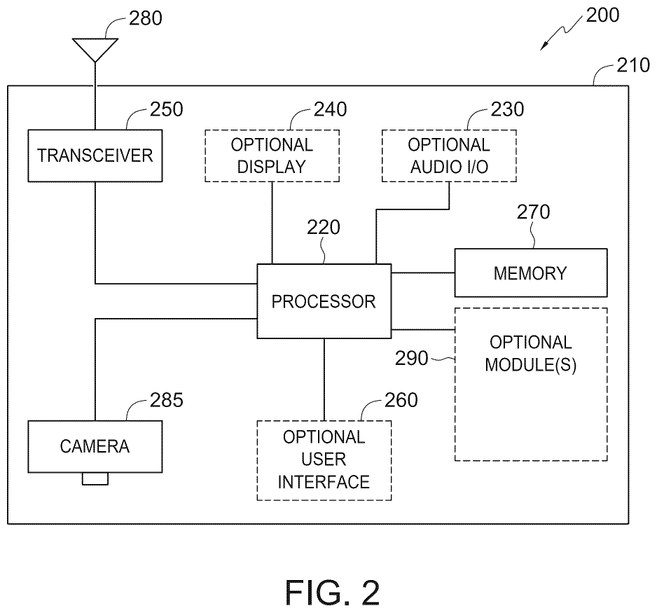

Geotagging involves providing geo-location information in metadata associated with a captured image. The grid asset monitoring apparatus 100 can include a satellite location receiver (not shown in FIG. 1 or 2) that receives location signals from location satellites that are in a low orbit around the Earth. A commonly used satellite location system is known as the Global Positioning System (GPS). Accordingly, the grid asset monitoring apparatus 100 may include a GPS receiver. The geotag data of the grid asset monitoring apparatus 100 may be sent as metadata with each of the images captured by the grid asset monitoring apparatus 100 and communicated from the grid asset monitoring apparatus 100 to the remote computing device/system 130, as part of an installation protocol at or about the time the grid asset monitoring apparatus 100 is installed. These images and associated data can be date-stamped and stored in a database, and can be used with AI techniques, to gain enhanced or deeper data concerning monitored areas, the passive structure and active electronic devices (such as IoT devices) and background in a monitored area and images in such monitored areas, an installation location or grid, etc., for example.

Likewise, the actual or estimated geocoordinates coordinates of the monitored areas, can be manually input, corrected or estimated at installation or later.

In the exemplary embodiment shown in FIG. 1, the monitoring device 100 is shown aerially mounted to a utility pole at an installation location 110, which may be along the side of a street, in a field, in a parking lot, etc. A power generation plant typically provides electric power along high voltage transmission lines 120 (e.g., tens or hundreds of kilovolts AC), which is then stepped down in voltage for distribution via a feeder or lateral distribution infrastructure 105 (e.g., distribution lines, poles, and transformers, and other infrastructure components) to the lower voltage installation location 110. Advantageously, having accurate estimated or actual location information for monitored areas can be beneficial, so that in the case of unusual activity, such as an event, unusual behavior (e.g., extreme weather, temperature, loss of network connection), out of tolerance readings or images, or a near event, a troubleshooting, diagnostic and self-repair routine or protocol can be implemented immediately, in an automated way or manually. The troubleshooting, diagnostics, analytics and self-correct (or self-repair) protocol or tool (TDAS Protocol or TDAS Tool), can be viewed as a first (or initial) line of defense and is adapted to self-correct, self-reset or self-repair the operation of a grid asset monitoring apparatus and structure and devices in a monitored area. In the event that the first line of defense is not successful, the TDAS Protocol is adapted to provide suggestions or identify candidate area(s), structure or active devices, such as IoT devices, in a monitored area, for further investigation.

As should be understood, as the database matures and the experience base expands with increasing numbers of incident resolutions, the TDAS Tool can be improved and enhanced to expand its portfolio of solutions, not only for a first round of defense, but also for deeper and more complex incidents. More specifically, the TDAS Tool's routines, algorithms, analytics, diagnostics and capabilities concerning self-correcting solutions can expand or learn and be more effective with a greater experience base of reported incidents. It is believed that using AI techniques, some of which are detailed herein, can help this effort. Again, as the database grows and improves, other databases such as weather patterns, seasonal patterns, terrain, environmental data and foliage growth patterns and forecasts can be used to enhance the TDAS Protocol.

In addition, it should be understood by those skilled in the art, that the geometry, volume, 3D footprint, shape and size of a grid asset monitoring apparatus 100, 200 and its housing 210, can vary widely. For example, each grid asset monitoring apparatus 100, 200 may range from the size of a typical cellphone to much larger, to accommodate the desired componentry and/or to add further components, functions and accessories. Beneficially, a grid asset monitoring apparatus with a smaller footprint configured in a lockable holster could be adapted to being easily attachable and detachable, thus making replacement of such a device simple and automatable, with minimal human intervention.

FIG. 2 is an exemplary block diagram of a wireless communication device, such as grid asset monitoring apparatus 200, according to an exemplary embodiment. The grid asset monitoring apparatus 200 can include a housing 210, a processor 220 located within the housing 210, optional audio input and output circuitry 230 located within the housing 210, an optional display 240 positioned in a window of the housing 210, a transceiver 250 positioned within the housing 210, an optional user interface 260 positioned within the housing 210, memory 270 positioned within the housing 210, an antenna 280 coupled to the transceiver 250 and positioned within and/or coupled to the housing 210, and one or more cameras 285 (one shown for illustration purposes in FIG. 2, although the grid asset monitoring apparatus 100 is shown in FIG. 1 to include multiple cameras). The grid asset monitoring apparatus 200 can further include various module(s) 290, which can include a power module, an AI module, and an accessory module coupled to or forming part of the processor 220. The module(s) 290 can reside within the processor 220 or the memory 270, can be autonomous, can be software, can be hardware, or can be in any other format useful for a module in a field-installed, wirelessly communicating, electronic device.

The display 240 can be a liquid crystal display (LCD), a light emitting diode (LED) display, a plasma display, or any other means for displaying information. The transceiver 250 includes a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 may include a random access memory, a read only memory, an optical memory or any other memory that can be coupled to a wireless communication device.

In FIG. 2, the grid asset monitoring apparatus 200 can further include: a camera 285 configured to monitor a monitored area in proximity to a location associated with an utility infrastructure and capture image data associated with a monitored area; memory 270 that stores at least processor-readable operating instructions; at least one processor 220 that is operable in accordance with the processor-readable operating instructions to: analyze the captured image data to detect whether a condition associated with the monitored area of the utility infrastructure is within a threshold pattern or outside the threshold pattern defining an event; and trigger an alert signal if the condition associated with the monitored area qualifies as an event; and a wireless transceiver 250, coupled to the processor 220, operable to transmit information to a remote computing device/system 130.

Advantageously, the grid asset monitoring apparatus 100, 200 is adapted to help troubleshoot, diagnose, mitigate, resolve or flag an event or near event quickly. This can be done manually, on-line or in an automated fashion, with little or no human intervention. In some cases, field personnel will need to be dispatched on site and in some, a drone or robot can be utilized. Another benefit is that the database of images and meta data from a grid asset monitoring apparatus 100, 200 allows one to do analytics, diagnostics and data review to be able to anticipate risks of future incidents, events and near events and operational disruptions. Thus, a database including image information, operational measurements, operational characteristics, parameters and the like can provide detailed and actionable information to resolve and predict incidents and event triggers, manually, on-line or in an automated fashion.

In one exemplary embodiment in FIG. 2, operating instructions executed by the processor 220 to analyze the captured image data to detect whether a condition associated with the monitored area of the utility infrastructure is within a threshold pattern or outside the threshold pattern defining an event; and trigger an alert signal if the condition associated with the monitored area qualifies as an event. This can be accomplished by image recognition and/or computer vision techniques, which can be proprietary or off-the-shelf. Some popular vendors in this space include Google Cloud Vision API, Amazon Rekognition, Clarifai and Microsoft Computer Vision API and Video API. Image recognition can be defined as a set of algorithms and techniques to label and classify the elements inside an image. Image recognition focuses on contents inside an image. Image recognition models are trained to take an input image and output previously classified labels that define the image. It has been suggested that image recognition technology can be thought of as an imitation of the techniques that animals use to detect and classify objects.

Although image recognition and computer/machine vision may appear to be interconnected terms, image recognition is generally thought of as a subset of computer vision. Image recognition is a technique for identifying the content of an image. Computer vision involves obtaining, describing and producing results according to the field of application. Image recognition can be considered as a component of computer vision software. Computer vision is believed to have more capabilities like event detection, learning, image reconstruction and object tracking. Machine vision is a vision system involving both hardware and computer vision software. Therefore, computer vision and image recognition can be considered as components of machine vision software. Model training is necessary for an image recognition model to work. Deep learning methods are generally considered effective performing tools to train image recognition models. In order for an image recognition model to work, first there must be a data set. Consider a newborn baby, in order for the baby to identify the objects around him or her, the objects must first be introduced by his parents. The process is similar for machines, there is a data set and using deep learning techniques, the model must be trained in order to perform.

An image is a number of pixels to a computer. In order to make a meaningful result from this data, it is necessary to extract certain features from the image. This process is called feature extraction. Feature extraction allows specific patterns to be represented by specific vectors. Deep learning methods can also be used to determine the boundary range of these vectors. At this point, a data set is used to train the model, and in the end the model predicts certain objects and labels the new input image into a certain class. In one a healthcare application, for example, detecting tumors from X-rays and MRI scans can provide a use cases of image recognition. In recent publications, author's have represented that by using image recognition algorithms from X-rays and/or MRI scans, certain algorithms and techniques successfully detected lung cancers with a high degree of accuracy, such as with a 97 percent accuracy.

In another example, facial recognition is a branch of image recognition and works with similar rules for identifying patterns in images. The technology works by pinpointing the facial features (landmarks) of an image and comparing them with other images from the database. It is adapted for use with AI algorithms as well.

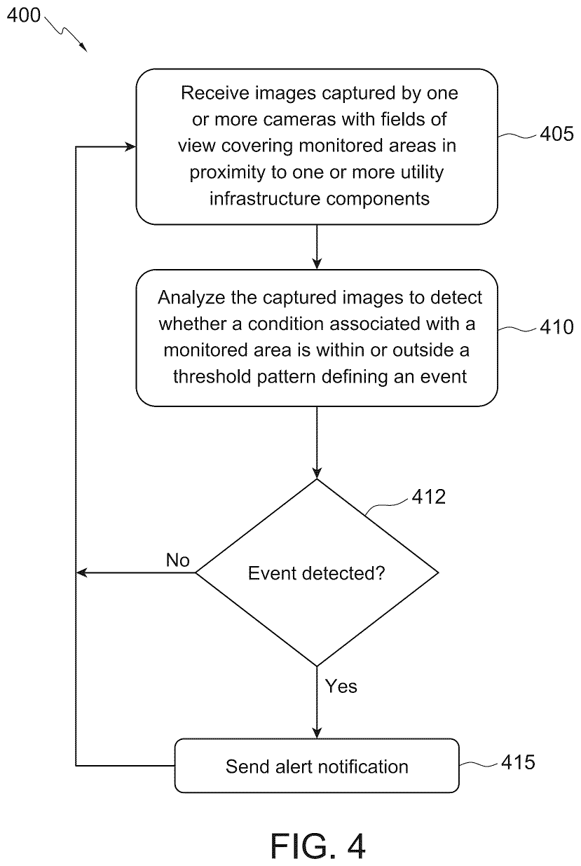

In exemplary embodiments in FIGS. 2 and 4, the processing and analysis in connection with processor 220, can be accomplished by proprietary algorithms and off-the-shelf image and data processing tools in analyzing a particular monitored area image. The images can be thought of as a portrait of rows and columns of pixels, including vertical and horizontal lines, arcs, shapes and objects of various dimensions, which can form landmarks or artifacts. In this disclosure, in connection with analyzing and/or processing instructions, the software can recognize power lines, vertical power poles, horizontal support structure with power line supports, transformers, IoT devices and various components associated with utility structure, as well as vegetation, backgrounds or terrains and other objects in the image of interest.

In sum, in one embodiment, an initial image or baseline is taken/scanned in a monitored area. Next, subsequent images are made of the same monitored area and stored in a database. In the event that a subsequent image from such monitored area falls within a predetermined threshold or tolerance, such as within a four percent variance, the subsequent image would pass as within the predetermined threshold (or tolerance). If, however, the subsequent image is not within the predetermined threshold, an event trigger is initiated, which would warrant further investigation. Typically, relevant parameters, near events and tolerance related readings are documented in the database. Knowing these parameters, etc. can dictate maintenance schedules, as well as enable use of artificial intelligence algorithms to predict when a computing device, transformer, IoT device, etc. may need maintenance or replacement, for example.

More specifically, in one exemplary embodiment, parameter data and operating information can be measured and/or recorded for a more thorough database, for enhanced intelligence about a given monitored area. For example, a minor powerline sag, pole tilt, horizontal support structure tilt, minor vegetation growth, minor flooding, etc. measurements and data can be recorded, and if within a predetermined threshold or tolerance, would not be flagged as an event. As time passes, improvements, modifications and adjustments from lessons-learned (historical data), can be made to tighten or loosen the pre-determined thresholds (or tolerances). As should be understood, having an accurate and thorough database (with reliable and actionable data, for example) and experienced operators, such experienced operators can develop alone or with the use of AI and analytics, additional and helpful suggestions for further improvements and efficiencies.

In an exemplary embodiment in FIG. 3, at the time the grid asset monitoring devices 322, 324, 326, 364 are installed, it is deemed good practice if a survey is done identifying all related infrastructure, components, terrain and various locations, including the location of each monitored area preferably with accurate location information, such as geolocations, GPS coordinates or the like. Obviously, such a survey can be done later, as layouts and designs are often modified, lines are re-routed and the like. This survey data can be recorded and stored in a database, likely at a remote computing device 130 and/or in the cloud. As should be understood, accurate survey information and data would be helpful, so when new and/or improved modifications and equipment improvements are made, installers, surveyors and designers have a clear understanding of equipment location, terrains and desired placement of components/equipment in the vicinity of the installation site. Thus, in an exemplary embodiment, when images are taken from grid asset monitoring devices 322, 324, 326, 364, they are date stamped and accurate monitored area locations, such as GPS coordinates, are recorded and stored. However, in the real world, this process of surveying the installation and recording the precise location of each pole in distribution feeder 308 and overhead lateral pull off 312, for example, may not have been done and/or may not have accurate information.

Accordingly, in an exemplary embodiment the grid asset monitoring devices 322, 324, 326 and 364 can include rangefinder technology, which can determine distances from a camera to a focal point in a monitored area with the use of a laser beam technology, similar to what is used in golf rangefinders, for example. This technology is useful at initial set-up or thereafter for estimating locations of monitored areas. The technology it uses is similar to that of an autofocus camera. The key to accuracy is focusing on the correct focal point (pin-seeker ability) and not the background objects. After a laser beam is sent to the intended target, a distance reading is indicated on a display. In one embodiment, this rangefinder technology can be used to approximate a particular monitored area geolocation, such as a GPS coordinate from a camera, for an accurate (first level) geolocation estimate of a monitored area of interest, correction of previous inaccurate GPS coordinates and/or confirmation of previous location information (GPS coordinates). In sum, the distance from the monitored area is measured using a laser, and can be added to the camera GPS coordinates, to come up with an estimated GPS coordinate, in one embodiment. Advantageously, accurate location information (such as GPS coordinates) can provide clarity for infrastructure field workers investigating operational issues, events, near events and irregularities associated with a monitored area(s).

In one embodiment, the remote computing device 130, as controlled through the asset management and control panel display 132 can be used wirelessly to control, adjust, monitor and display images from the camera 150 in and around a monitored area, to get real time information concerning the status and condition of a monitored area and vicinity. In more detail, the grid asset monitoring apparatus or device 100 can be networked to a centralized facility, such as a remote or local command and control (data) center 130 and 135, from which an operator of the system can monitor system operations and be notified of any irregularities or events. The grid asset monitoring apparatus 100 can be queried continually, periodically, regularly, or as requested (e.g., polled) from a remote computing device 130, from which an operator of the system can monitor system operations through its allocated or assigned asset management and control panel display 132 and be notified of any irregular events. Operators can stream video from a camera real-time or near real time, to remotely investigate a desired monitored area. The remote computing device/system 130 can receive monitored data from the grid asset monitoring apparatus 100 (or many such devices) on a scheduled basis and can record a history of the operation of such devices. Such information can provide a database for AI usage. Such monitored data can include operating parameters (or a combination of operating parameters) of a monitored device or monitored area with and/or whether such parameters exceed or do not meet a threshold and can be reported with a flag or code that causes the remote computing device/system 130 to alert personnel or otherwise draw attention to a trigger event or potential trigger event. For example, a trigger event may comprise the generation of a message, such as an email or text message, to a human operator to notify a person of the event via the operator's cellphone 145.

In one exemplary embodiment, a camera or each camera may be a fisheye lens camera with a semispherical or part thereof field of view and/or may include pan, tilt, and zoom (PTZ) functionality for enhanced flexibility in connection with monitoring a particular area of interest in the proximity of the utility infrastructure. In some cameras with PTZ functionality, the PTZ settings of the camera are manually configured either remotely or on-site during installation, while for other cameras with auto-focus or other auto-configuration or auto-adjustment intelligence, the PTZ settings for the camera are managed by control circuitry of the camera or imaging sensor.

In one embodiment, the alert signal includes identification information of the monitored area associated with an utility infrastructure or utility installation. Beneficially, providing identification information can provide useful substantially real-time status information and the condition of a monitored area where an alert signal has been triggered. For example, the identification information can help to expedite an investigation, as it could provide asset information, model numbers of products, bar code or an optical code (e.g., a QR code) or parts in the monitored area and the like, which is useful to plan or troubleshoot, for a quick resolution.

In one embodiment, the captured image data includes at least one of location information and identification information. Advantageously, providing accurate or estimated geolocation information, GPS coordinates, latitude and longitude information, utility infrastructure address and/or street address related information, can provide a reliable location to dispatch a field crew to, for example, expedite repair, for a quick resolution.

In another embodiment as shown in FIG. 2, a grid asset monitoring apparatus 200 can include an accessory module including at least one of a monitoring device, a sensor device and an Internet of Things device. Advantageously, the accessory module can help to efficiently interface, communicate and signal with a monitoring and/or sensing module and provide Internet of Things (IoT) functionality. In more detail, a monitoring and/or sensing module can be packaged and directly integrated in the grid asset monitoring apparatus 200 through processor 220 or wirelessly connected via transceiver 250. In this instance, additional information and intelligence can be gained in connection with various functions and conditions, in connection with a monitored area, for example. This can provide improved and more reliable supplemental intelligence for troubleshooting, diagnostics and remote and on-site repair.

In another embodiment, the grid asset monitoring apparatus 200 monitors at least one of a distribution transformer (e.g., see monitored area 366, in FIG. 3), streetlight 360 and internet access point 360. Advantageously, monitoring such devices can help to detect irregular events associated with utility infrastructure, for example.

In one exemplary embodiment, the grid asset monitoring apparatus 200 can include a database configured to document and store data associated with the activity and operations of a computing device. The database can be a single database or multiple databases. In some cases, hardware or software storage repositories are shared among various functions of the particular system or systems to which they are associated. A database may be formed as part of a local system or local area network. Alternatively, or in addition, a database may be formed remotely, such as within a distributed “cloud” computing system, which would be accessible via a wide area network or some other network.

In more detail, the database can be coupled to at least one of a machine learning technique and an AI module, configured to update and expand, over time, the stored data. In yet further detail, the database can be coupled to an AI module configured to update and expand, over time, the stored data, the AI module including at least one technique concerning machine learning, neural networks, deep learning using neural networks and computing power to find patterns in data concerning images, cognitive computing, computer vision using pattern recognition and deep learning to explore and/or interpret the content of images or videos, and natural language processing.

As used in this disclosure, AI can generally be considered a family of technologies or techniques that perform tasks that are thought to require intelligence if performed by humans. One of the main categories is narrow intelligence, which can involve achieving competence in a narrowly defined domain, such as analyzing images. Typically, use case applications of AI involve domains with large amounts of data. To use the radiology and monitored area images examples above, the existence of large databases of X-rays and MRI scans and monitored area images that can or have been evaluated by human radiologists and utility personnel, respectively, makes it possible to train a machine to emulate that activity. AI can generally work by combining large amounts of data with intelligent algorithms, or series of instructions, which allow the software to learn from patterns and features of the data. In simulating the way a brain functions, AI can utilize a group of different subfields. The term subfield can be defined as a field that is a subset of a given field. For example, machine learning can automate analytical model building to find hidden insights in data without being programmed to look for something in particular or draw a certain conclusion. Neural networks can imitate the brain's array of interconnected neurons, and relay information between various units to find connections and derive meaning from data. Deep learning utilizes large neural networks and a lot of computing power to find complex patterns in data for applications such as image recognition. Computer vision employs pattern recognition and deep learning to understand the content of images and videos, and to enable machines to use real-time or stored images to make sense of the vicinity. These AI related techniques can be useful and adaptable in connection with the grid asset monitoring apparatus 100, 200 and method 400 to enhance, improve and refine the operation and steps in method 400 and the grid asset monitoring apparatus 100, 200, for example.

FIG. 3 is an environmental view of an exemplary embodiment of a power distribution network 300. As background, a typical utility entity can maintain and operate hundreds of grids or power distribution networks like the one shown in FIG. 3. The generation and transmission portions of the grid include one or more electric power generation facilities 302, various step up and step down transformers, and transmission power lines aerially attached by support structures 304 leading and connected to a distribution substation 306. The generation facility 302 and the transmission power lines can provide electric power at high transmission voltage levels (e.g., tens to hundreds of kilovolts AC). At the distribution substation 306, the power is processed, conditioned and/or stepped down to a retail standard level (e.g., 120 VAC, 240 VAC, or 480 VAC). Next, power lines from the distribution substation 306 at the lower level are fed to a distribution feeder 308, for retail use, using lateral pull offs such as overhead lateral pull off 312 and underground lateral pull off 314 and secondary cables, such as overhead secondary cable 318 and underground secondary cable 320, which are connected and configured to deliver power to residents. As understood, this infrastructure and supporting components are exposed to the harsh outdoors and are often prone to damage by extreme weather and temperatures, wind, ice, snow, rain, flooding, animal and human interference and the like. Also, FIG. 3 is not drawn to scale, so the distances between the power generation facility 302 to the distribution substation 306 and from the distribution substation 306 to the distribution feed 308 can be many miles. Likewise, the length of the distribution feed 308 can also be quite long and the number of residences shown in FIG. 3, could vary in number.

In view of these extreme conditions, it would be beneficial to have a network of grid asset monitoring devices to monitor the operations and conditions of an utility infrastructure. In FIG. 3, the distribution feeder 308 is shown for illustration purposes as being monitored by three grid asset monitoring devices 322, 324, 326, each including five cameras having associated fields of view at predetermined or adjustable angles, such as 0 degrees, 45 degrees, −45 degrees, and so forth, which are shown with dashed arrows in FIG. 3 directed toward exemplary, rectangularly shaped monitored areas (also shown in dashed lines). For example, grid asset monitoring device 322 monitors areas 328, 330, 332, 334, 336. Grid asset monitoring device 324 monitors areas 338, 340, 342, 344, 346. Lastly, grid asset monitoring device 326 monitors areas 348, 350, 352, 354, 356. Each grid monitoring device 322, 324, 326 may constitute the elements of a grid monitoring apparatus 100, 200, as described with respect to FIGS. 1 and 2.

In connection with monitored area 328, a lamp support 358 is shown with a downwardly directed streetlight 360 and upwardly extending internet access point 362. Further structure is shown in monitored area 328 including a portion of a vertical power pole, a horizontal cross support and power lines. In use, if one or more components of this structure falls outside a predetermined threshold, an event signal is triggered by grid asset monitoring device 326 and recorded and sent to a remote computing device 130 for further investigation. In one exemplary embodiment, grid asset monitoring device 326 can visually monitor monitored area 328 as well as be connected and networked to monitor IoT devices, such as the streetlight 360 and access point 362, to monitor the various parameters of: the streetlight 360, such as on/off status, power consumed, operating voltage and/or current and other parameters; and the access point 362. In addition, test protocols can be exchanged between such devices to determine the operating status, for example. This is just one example of a wide variety of equipment that can be installed and monitored. As should be understood, this test or audit procedure can be done automatically or manually, with any cadence, with many of the devices mentioned in this disclosure that are IoT compatible devices.

In another exemplary embodiment shown in FIG. 3, another grid asset monitoring device 364 is shown strategically located and aerially mounted to an utility infrastructure, to gain a wide overview of a desired location, such as a utility or power grid installation. Grid asset monitoring device 364 can include one or more cameras that includes pan-tilt-zoom (PTZ) functionality, so that a plurality of monitored areas can be monitored and examined. Further, it can be remotely controlled for real-time video streaming from a remote computing device 130 as shown in FIG. 1, for example. In more detail, grid asset monitoring device 364 is strategically positioned to monitor by line of sight, many or most of the components associated with the distribution feeder 308, including overhead and underground lateral pull offs 312, 314 and other areas in the vicinity, as illustrated in FIG. 3. Grid asset monitoring device 364 can be operated manually or in an automated or pre-programed fashion, in a predetermined cycle or when an irregular or abnormal condition or event is sensed or triggered.

In a first example, grid asset monitoring device 364 can have preassigned or preprogrammed monitored areas to examine along overhead or underground lateral pull offs 312, 314. In a second example, in the event that a vibration event has been sensed at a particular pole connected to a computing device, this could indicate an automobile has struck such pole. In a third example, a loud noise could be sensed by a microphone, such as thunder, fireworks or a gun shot fired in the vicinity of an installation facility connected to a computing device, potentially damaging expensive grid associated components. In a fourth example, proximity sensors connected to a grid asset monitoring device can trigger an event when an unauthorized drone is flown too close to a particular infrastructure component or segment. In such events, one or more cameras can begin a systematic protocol of monitoring, recording the location, and/or tracking movement of animals, cars, drones or people, for example. The grid asset monitoring apparatus 100 can have a microphone and speaker, to warn a person or animal by voice or alarm, that they are too near a hazard or utility infrastructure or contact an injured person/driver, for example.

In addition, in one exemplary embodiment, grid asset monitoring device 364 can be configured and strategically located with a clear line of sight to maximize the number of important components it may be able to monitor. Strategic placement can provide context and a wide view audit or survey of a desired vicinity periodically or systematically, for example, during normal operations before an event is triggered. Conversely, grid asset monitoring device 364 can be triggered by any number of ways and detailed herein and/or by sensors, for real-time monitoring, recording and/or tracking. Grid asset monitoring device 364 can be configured to monitor a padmount distribution transformer located in monitored area 366, monitored area 368 for monitoring an aerially located transformer and power lines and monitored area 370 for monitoring a pole and power lines. This flexibility is made possible by the camera of grid asset monitoring device 364 having pan, tilt, zoom functionality. As should be understood by those skilled in the art, in exemplary embodiments, one or more grid asset monitoring apparatus 100, 200, grid asset monitoring device 322, grid asset monitoring device 324, and grid asset monitoring device 326 can include cameras with pan, zoom and tilt functionality and the number of cameras in each device can vary based on the use case, for example.

In further detail, in the exemplary embodiments of FIG. 3, a power distribution transformer is shown in monitored area 366. The transformer may have attached thereto an information label or plate that indicates a manufacturer, a serial number, a size or capacity, and various other parameters. In order to maintain the transformer, it is desirable to know the status of a number of transformer parameters, including, for example, oil level, oil temperature, tank temperature, tank pressure, ambient temperature, primary and secondary winding temperatures, secondary winding voltage, primary and secondary winding current, tilt, vibration, and surge arrester condition. Knowing these parameters can dictate maintenance schedules, as well as enable use of artificial intelligence algorithms to predict when a given transformer may need maintenance or replacement. In the past, such information had to be collected manually at the transformer, if it was collected at all. This required sending skilled lineman to the transformer with a bucket truck to access the transformer, which added substantially to the expense of operating a power distribution network.

To eliminate that expense and provide consistent and regular monitoring of the transformer (or any other utility grid asset or aerially mounted or remotely installed electrical or electronic device), a monitoring device with IoT functionality may be installed on the transformer or other monitored device. The monitoring device is coupled to various sensors in the transformer or other monitored device and can be wirelessly networked so that the monitoring device can continually, periodically, regularly, or as requested (e.g., polled) transmit operating parameter data to a centralized facility, such as a remote computing device 130, from which an operator of the system can monitor system operations and be notified of any irregular events. The remote computing device 130 may be maintained by the system operator or may be a cloud-based service offered by a service provider, such as a supplier of the grid asset monitoring devices 322, 324, 326, 364 or otherwise. Various thresholds may be set for operating parameters of a monitored device, such as the distribution transformer, which can be used to generate alerts or flags, to allow a system operator to decide what actions to take. Further, data generated by the monitoring device can be processed using predictive models to determine if a problem should be expected in the near future.

Turning to FIG. 4, an exemplary method for monitoring utility infrastructure stationed at an installation location is shown. The exemplary method may be performed by a processor 220 (e.g., an edge processor) within a grid asset monitoring apparatus 100, 200 or by a remote computing device 130 or system (e.g., a cloud-based service, application, or platform). The method includes receiving images (405) from one or more cameras (150, 160, 170, 180, 190, 285) with fields of view covering desired areas (monitored areas) in proximity to one or more utility infrastructure components (e.g., utility poles or towers, power cables, transformers, substations, etc.), analyzing the captured image data (410) to detect (412) whether a condition associated with a monitored area of the utility infrastructure is within or outside a threshold pattern defining an event (e.g., vegetation encroachment, water encroachment, human/animal encroachment, downed power lines, etc.), and when an event is detected, sending 415 an alert notification or signal directly to either an operator of the installed utility infrastructure or a server or cloud-based platform accessible by the operator of the installed utility infrastructure to inform of the occurrence of the event. Advantageously, the method 400 can help to facilitate troubleshooting and mitigate a potential problem or irregularity quickly, to get a power grid system back on-line as quickly and as safely as possible. Also, the method can help flag problems and/or alert a maintenance crew to a particular location or area of the infrastructure needing attention. As should be understood, a robot or drone could be used for diagnosing and/or repair as well, for example.

The method 400 can include providing at least one local command and control module and one remote command and control module. In one embodiment, the local and remote command and control modules can be a receiver which can be used to control, operate, adjust and display images from the camera in and around the monitored area, to get real time or historical information concerning the status and condition of the monitored area and vicinity. For example, command and control modules (or receivers) can be programmed to receive status and condition information, with various settable cadences, for example, periodically or continuously. Further, personnel at a command and control center can stream video from the camera to remotely investigate and monitor a desired monitored area or areas in a location of interest. For example, personnel at a command and control center, field personnel or AI can stream live or recorded video from a camera, to remotely investigate a desired monitored area relating to a historical, recent or current event. Likewise, as should be understood by those skilled in the art, a receiver such as a mobile communication device or terminal like a cellphone, PC or private 2-way radio system (often used by first responders, fire, police, local municipalities, utilities and corporations), can be utilized to communicate with and gain information in the field, for example, to investigate or get a system quickly back on-line and/or resolve a triggered event.

In one embodiment, the communicated alert notification includes identification information of the monitored area of the utility infrastructure, which can expedite an investigation. In one example, such information could provide asset information, model numbers of products or parts in the monitored area and the like. The alert notification can be used by the utility operator to dispatch a crew or drone to the identified location for quick resolution of the detected event.

In one embodiment, the captured image data includes at least one of location information and identification information. Advantageously, providing accurate or estimated location information, GPS coordinates, latitude and longitude information, utility infrastructure address and/or street address related information, can provide a reliable location to dispatch a field worker or robot/drone to, for maintenance, rapid repair and minimal down time, for example. Identification information can include an asset label, plate, or tag with identifying information such as, for example, a manufacturer name, serial number, build date, and other information. The information can be provided in both alphanumeric form that is readable by humans, and in a machine readable format, such as a bar code or an optical code (e.g., a QR code). Having this information can help to investigate and expedite resolution of a trigger or near trigger event.

In one embodiment, the monitoring step 405 can further include providing a grid asset monitoring apparatus or device including an accessory module configured to include at least one of a monitoring device, a sensor device and an Internet of Things device. Advantageously, the accessory module can provide useful information concerning location, ice/snow formation, vibration, temperature, microphone, speaker, display, humidity and proximity sensing, vegetation growth, bird nests, animal waste, flooding, smoke detection, lightening, wind and/or structural damage, distance from camera, etc. Having additional or supplemental information associated with the monitored area of interest could help in diagnosing and troubleshooting, for example. In more detail, the grid asset monitoring apparatus can have this additional monitoring, sensing or IoT functionality housed in or connected in a single device or be connected with one or more other networked devices, for additional important local information, for enhanced and smarter monitoring, sensing and the like.

In more detail, in one embodiment the accessory module includes a remote accessory module configured to connect to one or more IoT devices. The IoT device could be in or near a monitored area and can be wirelessly coupled to the transceiver 250 of the grid asset monitoring apparatus via its own transceiver. Stated differently, the IoT device could provide additional (independent) information, monitoring and sensing functionality/information in proximity to the monitored area of interest, for example. Further, the IoT device could sense local conditions or be connected to whether service, sense and/or measure weather status information, equipment status, etc. associated with an utility infrastructure or grid, for example. In one embodiment, the IoT device can be positioned in a monitored area, for enhanced information concerning, for example, location (e.g., GPS coordinates), ice/snow formation, vibration (motion sensing), temperature, humidity, proximity sensing regarding potential animal/people interference, vegetation growth, bird nests, animal waste, flooding, smoke detection, lightening, structural and electronic damage, microphone and speaker functionality, distance from camera, etc. Having additional or supplemental information associated with the monitored area of interest could help in diagnosing, troubleshooting and expediting repair, for example, and getting back on-line quickly. In one embodiment, the IoT device can be located in a monitored area of interest, such as shown at monitored area 328, where an access point 362 and streetlight 360 are shown connected and networked with grid asset monitoring device 326, in FIG. 3.

In another embodiment, the monitoring step 405 can include a grid asset monitoring apparatus and a remote IoT monitoring device for a distribution transformer. Additional helpful information can be gained, in this embodiment.

And in another exemplary embodiment, the monitoring step 405 can include a grid asset monitoring apparatus and an IoT device for at least one of monitoring and controlling a streetlight, transceiver and internet access point at monitored area 328 in FIG. 3. Advantageously, enhanced monitoring can be gained when such structure is placed in a monitored area of interest, for quick resolution of irregularities and rapid return to operational status, for example.

As should be understood, maintaining full operational status for utility entities can be challenging. Disrupting or interfering in it can have negative consequences. Accordingly, utility operators place a high priority on safeguarding the security of its assets, including utility privacy features, limited accessibility measures, cyber security defenses, authentication features and the like, to maintain the integrity of a secure communication and control system. Video monitoring of utility installations and equipment, which is a subject of this disclosure, can help to minimize incidents or potential interruptions resulting in the loss of full operational status. And, communications, monitoring, sensing and controlling utility systems with secure devices and processes with network, database and system integrity, is considered a prominent consideration as well, and is a subject of this disclosure. As should also be understood, a typical utility can maintain and operate hundreds of microgrids or power distribution networks, similar to the one shown in FIG. 3.

The grid asset monitoring apparatus 100, 200 can be powered in a conventional manner. In the vicinity of a power grid, stray electromagnetic fields are abundantly present, such as around power lines or cables. Inductive, capacitive and hybrids involving both types of electrodynamic energy harvesting can provide a good use case in connection with this disclosure. As previously mentioned, standard retail voltage levels are typically 120 VAC, 240 VAC, or 480 VAC, at many installation locations in FIG. 1. When an energy harvester is installed around a power line, the alternating current in the line causes a changing stray electromagnetic field surrounding the power line. In the inductive energy harvesting unit, use case, due to the alternating stray magnetic field, an emf will be induced in the individual turn of the wound coil according to Faraday's law of electromagnetism. As previously detailed, in a retail applications illustrated in FIGS. 1 and 3, voltages of 120 VAC, 240 VAC, or 480 VAC can be transformed from a power line to useful DC voltages (e.g., less than 50 volts DC), which can in turn be lowered and directly fed to electronic devices, such as the grid asset monitoring apparatus 100 and 200, with standard or conventional components.

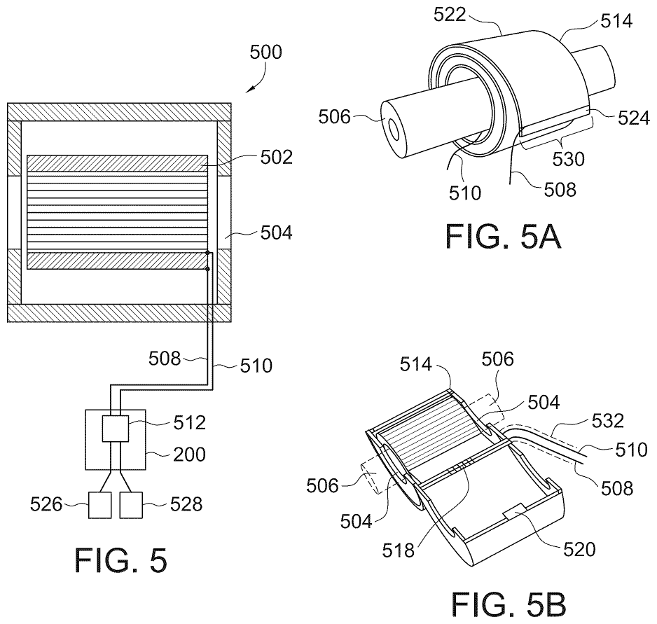

In simplified exemplary embodiments in FIGS. 1 and 5, each grid asset monitoring apparatus or device 100, 200, 322, 324, 326 can include a power harvesting assembly 196 coupled to a power line, as shown in FIG. 1. The power harvesting assembly 196 (also power harvesting assembly 500 in FIG. 5) can include an elongated single piece inductive ring 502 with a hole 504 adapted to receive a power line 506, at least a two-conductor cables 508 and 510 connected to the inductive ring 502 and an interface controller configured 512 (which could be a stand-alone controller or a processor 220 in a grid asset monitoring apparatus 100, 200) to operate and/or connect to an electrical device. The interface controller 512 can be configured to provide operating instructions to the power harvesting assembly 500, such as to operate, monitor and control power related features and associated structure for filtering, conditioning, monitoring, fault and surge detection, sensing, raising or lowering voltage levels, transforming voltages from ac to dc or vice versa, operating and powering a rapid or trickle charge to a battery pack 526 and accessory connections 528 for devices.

In more detail, in one embodiment, the accessory connection 528 can include powering and operating other electronic devices and/or can include powering and operating a heating and cooling device, to condition and maintain a pre-determined temperature range in proximity to the electronics and/or battery in an insulated enclosure, for example, in a grid asset monitoring apparatus 100, 200 or power harvesting assembly 500. In more detail, during extreme outside temperature conditions, such as above 90 degrees Fahrenheit and below 20 degrees Fahrenheit, it is useful to maintain electronics, batteries, etc. within a moderate temperature range of about 40 degrees Fahrenheit to about 65 degrees Fahrenheit, for reliable operations.

Advantageously, installing a power harvesting assembly near a power line (typically at an elevated height from the ground) can be efficient, less labor intensive and economical, rather than traditional power installation involving installing conduit and pulling wire through the conduit to feed power to a grid asset monitoring apparatus 100, 200, typically aerially mounted on a power or light pole structure.

In the field, a single piece inductive ring can present an installation challenge, as it cannot be mounted directly upon an in-service power line. In more detail, in this example, power would have to be disrupted, the power cable has to be disconnected and is then inserted in a central hole provided in a single piece inductive ring 502, as illustrated in FIG. 5.

In exemplary embodiments in FIGS. 5A and 5B, it is considered easier and more efficient if a power harvesting assembly 500 could be placed, assembled and installed on a power cable without disconnecting a power cable. For example, as illustrated in FIG. 5A, an inductive wrap 514 can be wrapped around a power line 506. Next, as illustrated in FIG. 5B, a housing 516, generally shaped as a hollow cylinder complementarily configured to receive the inductive wrap 514 in a middle portion and holes 504 at the ends configured to allow receipt of the power line 506, respectively, is provided. The housing 516 can be in the form of a hollow cylinder and can be longitudinally cut in half and can have a hinge 518 and locking structure 520, for secure placement along a power line and protection from extreme weather. The inductive wrap 520, for example, can include wire, such as a copper wire, wrapped around a width 530 several times, providing a plurality of windings, on a relatively long rectangular substrate 524. The substrate 524 is sufficiently long to be wrapped around the power line 506 more than once. In one embodiment in FIG. 5A, the substrate 524 is wrapped around the power line 506 between 2 and 3 times, for an efficient electromagnetic connection. The plurality of windings can produce a multiturn inductive energy harvester. The housing 516, the locking structure 520 and the hinge 518 provide a generally tubular securely mounted energy harvester adapted to be easily assembled and mounted to a power line 506, in the field. In one embodiment, a metallic plate, such as a thin layer of steel, can be utilized along substantially the entire length and width of the inductive wrap 514 as a structural stiffener with neutral or desirable electromagnetic characteristics.

In FIG. 5B, a conduit 532 (in phantom), can include conductors 1 and 2, 508 and 510, which can be fed to interface controller 512.

Referring to FIG. 5, in one exemplary embodiment, a DC voltage from ring 502 and inductive wrap 514 (in FIGS. 5A and 5B) can be coupled to interface controller 512. For simplification and purposes of this disclosure, the interface controller 512 or box 512, can also include various power circuitry, components and the like, to step down the DC voltage in conductors 508, 510 to, for example, 12 VDC or 6 VDC, for directly powering electronic devices, such as grid asset monitoring 100, 200. Alternatively, the DC voltage in conductors 508, 510 can be inverted to a standard AC level, such as 120 VAC, for powering a standard electronic device in the US, for example, and such devices would transform the 120 VAC to a low standard DC voltage to power their own circuits. As should be understood, various power techniques and circuits can be used, without departing from the scope of this disclosure.

In one exemplary embodiment, the substrate 524 can include a plate, and the plate can comprise a mild steel. Alternatively, the plate can be positioned inside or embedded within the substrate 524. The substrate 524 can form a mild steel core, for example. In use, when the power harvesting assembly 500 is properly installed around a power line 506 and functioning, the alternating current in the line causes a changing stray electromagnetic field surrounding the power line. Due to the alternating stray magnetic field, an electromagnetic field (EMF) will be induced in the individual turns of the wound coil according to Faraday's law of electromagnetism.

As should be understood, the grid asset monitoring apparatus 100, 200 can provide a privacy feature, access feature and authentication feature, for enhanced, confidential and secure communications.

In another exemplary embodiment, many of the devices previously discussed in the figures are capable of wireless networked communication. The particular wireless communication protocol used by each monitoring device can vary, however. For example, a cellular data connection can be used in some applications, while in other applications, a wireless local area network (e.g., Wi-Fi) can be used. The particular communication protocol used by an IoT device or networking device may depend on the location of the installed equipment and the communication resources that are available at that location. After the installation is complete, the grid asset monitoring devices 322, 324, 326, 364 should operate as desired. The installation information communicated to the remote computing device 130 includes information about the grid asset monitoring devices that allow the remote computing device 130 to communicate directly with the grid asset monitoring devices 322, 324, 326, 364 over an applicable wireless link. Thereafter, the grid asset monitoring devices 322, 324, 326, 364 and the remote computing device 130 communicate as programmed and/or as appropriate. Likewise, many of the components in and around the monitored areas are IoT devices that are capable of being networked and in communication with the remote computing device 130. Thus, a benefit of a wirelessly networked grid, is that when an out of threshold image is triggered for a particular grid asset monitoring apparatus 100, 200, such device can perform and send a secondary (or confirmatory) test. For example, it can attempt to communicate with an IoT device in a monitored area of interest, to run a test protocol to determine whether such IoT device is operating or not, notwithstanding having triggered an event. Thus, the image of an IoT device in the monitored area may be outside a pre-determined threshold according to an image taken but may still be operating. On the other hand, the image of an IoT device in a monitored area that triggered an event may be non-operational or partially operational, confirming the event trigger is valid and not a false trigger, which status has been confirmed by a test protocol. In any event, if such an IoT device is non-operational, it is possible to send a reset to restart such device, manually or automatically. If successful, the system has fixed itself. If not successful, a signal to perform a self-diagnosis routine can be initiated, manually or automatically. Advantageously, the grid asset monitoring system, apparatus, and method disclosed herein can help to troubleshoot, diagnose, mitigate and resolve a potential problem or irregularity, quickly with minimal or no need for human intervention.

In accordance with some embodiments of the present disclosure, a grid asset monitoring apparatus 100, 200 includes at least one camera 285, memory 270, and a processor 220. The camera 285 (or each camera, where multiple cameras 150, 160, 170, 180, 190 are included) is configured to capture images of at least one monitored area 155, 165, 175, 185, 195 in proximity to one or more installed utility infrastructure components (e.g., utility poles, power lines, transformers, etc.). The camera has at least one field of view covering the at least one monitored area 155, 165, 175, 185, 195. The images may be captured continuously, on demand through commands sent from a remote computing device 130, or at scheduled intervals. The memory 270 is configured to store processor-readable operating instructions and at least temporarily store image data for the images captured by the camera 285 or cameras 150, 160, 170, 180, 190. The processor 220 is operable in accordance with the processor-readable operating instructions to retrieve the image data from the memory 270, analyze the image data to determine whether an event related to an infrastructure component of the one or more utility infrastructure components is occurring or has occurred in a monitored area, and when an event is detected, communicate an alert for the event (e.g., to a remote computing device/system 130). For example, the processor 220 may use machine learning, image recognition, or computer vision artificial intelligence (AI) models or algorithms to analyze the captured images to detect vegetation encroachment on or toward power lines over time, sparking or fire on power lines or near a utility pole due to a lightning strike or a wildfire, flooding near a transformer, or animal or human encroachment near a transformer or utility pole. The grid asset monitoring apparatus 100, 200 may be secured to the utility infrastructure component being monitored or to another structure near the utility infrastructure component being monitored (e.g., secured to a utility pole to monitor another utility pole, a transformer mounted to the other utility pole, and/or power lines, for example).

In accordance with alternative embodiments of the present disclosure, the grid asset monitoring apparatus 100, 200 may include a wireless transceiver 250 (e.g., a cellular modem) operably coupled to the processor 220. In such cases, the processor 220 may communicate the alert through the wireless transceiver 250 to a remote computing device/system 130.

In accordance with further alternative embodiments of the present disclosure, the grid asset monitoring apparatus 100, 200 may include means, such as a power harvesting assembly 500, for inductively coupling electromagnetic energy from a power cable supported by one or more utility infrastructure components and means, such as an alternating current (AC)-to-direct current (DC) converter, rectifier, or regulator, for converting the electromagnetic energy to DC power for use by the camera(s) 150, 160, 170, 180, 190, 285, the memory 270, the processor 220, and any other components of the grid asset monitoring apparatus 100, 200 that require DC power to operate.

In accordance with further alternative embodiments of the present disclosure, the grid asset monitoring apparatus 100, 200 may include a plurality of cameras 150, 160, 170, 180, 190. In such embodiments, each camera of the plurality of cameras has at least one field of view covering one or more monitored areas in proximity to one or more infrastructure components.

In accordance with other alternative embodiments of the present disclosure, a grid asset monitoring system includes a plurality of grid asset monitoring devices 322, 324, 326, 364 positioned so as to permit monitoring of a plurality of monitored areas 328, 330, 332, 334, 336, 338, 340, 342, 344, 346, 348, 350, 352, 354, 356, 366, 368, 370 in proximity to a plurality of utility infrastructure components and a remote computing device 130 in communication with the grid asset monitoring devices 322, 324, 326, 364. In such embodiments, each grid asset monitoring device monitors at least one monitored area of the plurality of monitored areas and includes at least one camera 150, 160, 170, 180, 190, 285, memory 270, a processor 220, and a wireless transceiver 250. The camera 285 (or each camera, where multiple cameras 150, 160, 170, 180, 190 are included) is configured to capture images of at least one monitored area in proximity to one or more installed utility infrastructure components. The camera 285 has at least one field of view covering the at least one monitored area. The images may be captured continuously, on demand through commands sent from the remote computing device 130, or at scheduled intervals. The memory 270 is configured to store processor-readable operating instructions and at least temporarily store image data for the images captured by the camera 285 or cameras 150, 160, 170, 180, 190. The processor 220 is operable in accordance with the processor-readable operating instructions to retrieve the image data from the memory 270, analyze the image data to determine whether an event related to an infrastructure component of the one or more utility infrastructure components is occurring or has occurred in a monitored area, and when an event is detected, communicate an alert for the event to the remote computing device 130 via the wireless transceiver 250. The remote computing device 130 is operable to receive alerts from the grid asset monitoring devices 322, 324, 326, 364 and present alert notifications to an operator of the utility infrastructure components through an asset management and control panel display 132 (e.g., multilayered dashboard) allocated to the operator and available as part of a web application accessible by the operator through a web browser or downloaded client application.

In accordance with other alternative embodiments of the present disclosure, each grid asset monitoring device 322, 324, 326, 364 of the grid asset monitoring system may include means, such as a power harvesting assembly 196, 500, for inductively coupling electromagnetic energy from a power cable supported by one or more utility infrastructure components and means, such as an AC-to-DC converter, rectifier, or regulator, for converting the electromagnetic energy to DC power for use by the camera(s) 150, 160, 170, 180, 190, 285, the memory 270, the processor 220, the wireless transceiver 250, and any other components of the grid asset monitoring apparatus 100, 200 that require DC power to operate.

In accordance with other alternative embodiments of the present disclosure, a method for monitoring one or more installed utility infrastructure components is executable by a processor 220 fixedly positioned in proximity to the one or more installed utility infrastructure components (e.g., secured to one of the utility infrastructure components or a structure in proximity to the one or more utility infrastructure components). According to the method, the processor 220 retrieves, from a memory 270, image data for images captured by at least one camera 285, where the camera 285 (or each camera, where multiple cameras 150, 160, 170, 180, 190 are included) has at least one field of view covering at least one monitored area in proximity to the one or more installed utility infrastructure components. The processor 220 analyzes the image data to determine whether an event related to an installed infrastructure component is occurring or has occurred in a monitored area. When the processor 220 detects an event, the processor 220 communicates an alert (e.g., via a wireless transceiver 250) to a remote computing device 130 to facilitate presentation of an alert notification to an operator of the installed infrastructure component or components, such as through an asset management and control panel display 132 (e.g., multilayered dashboard) allocated to an operator installed utility infrastructure components and available as part of a web application accessible by the operator through a web browser or downloaded client application.

The claims appended hereto are meant to cover all modifications and changes within the scope and spirit of the present disclosure.

What is claimed is:

1. A grid asset monitoring apparatus comprising:
at least one camera configured to capture images of at least one monitored area in proximity to one or more installed utility infrastructure components, the at least one camera having at least one field of view covering the at least one monitored area;
memory configured to store processor-readable operating instructions and at least temporarily store image data for the images captured by the at least one camera; and
a processor operable in accordance with the processor-readable operating instructions to:
retrieve the image data from the memory;
analyze the image data to determine whether an event related to an infrastructure component of the one or more utility infrastructure components is occurring or has occurred in the at least one monitored area; and
when an event is detected, communicate an alert notification for the event.

2. The grid asset monitoring apparatus of claim 1, further comprising:
a wireless transceiver operably coupled to the processor, wherein the processor communicates the alert through the wireless transceiver to a remote computing device.

3. The grid asset monitoring apparatus of claim 1, further comprising:
means for inductively coupling electromagnetic energy from a power cable supported by the one or more utility infrastructure components; and
means for converting the electromagnetic energy to direct current power for use by the at least one camera, the memory, and the processor.

4. The grid asset monitoring apparatus of claim 1, wherein the at least one camera includes a plurality of cameras and wherein each camera of the plurality of cameras has at least one field of view covering one or more monitored areas of the at least one monitored area.

5. The grid asset monitoring apparatus of claim 1, wherein an event related to an infrastructure component includes vegetation encroachment within a monitored area in proximity to the infrastructure component.

6. A grid asset monitoring system comprising:
a plurality of grid asset monitoring devices positioned so as to permit monitoring of a plurality of monitored areas in proximity to a plurality of utility infrastructure components, each grid asset monitoring device monitoring at least one monitored area of the plurality of monitored areas and including:
at least one camera configured to capture images of the at least one monitored area, the at least one camera having at least one field of view covering the at least one monitored area;
memory configured to store processor-readable operating instructions and at least temporarily store image data for the images captured by the at least one camera; and
a processor operable in accordance with the processor-readable operating instructions to:
retrieve the image data from the memory;
analyze the image data to determine whether an event related to an infrastructure component of the plurality of utility infrastructure components is occurring or has occurred in the at least one monitored area; and
when an event is detected, communicate an alert for the event; and
a wireless transceiver operably coupled to the processor, wherein the processor communicates the alert through the wireless transceiver; and
a remote computing device operable to receive the alert from the grid asset monitoring device and present an alert notification to an operator of the plurality of utility infrastructure components through an asset management and control panel display allocated to the operator.

7. The grid asset monitoring system of claim 6, wherein each grid asset monitoring device further includes:
means for inductively coupling electromagnetic energy from a power cable of the one or more utility infrastructure components; and
means for converting the electromagnetic energy to direct current power for use by the at least one camera, the memory, the processor, and the wireless transceiver.

8. A method executable by a processor fixedly positioned in proximity to one or more installed utility infrastructure components, the method comprising:
retrieving, from a memory, image data for images captured by at least one camera, the at least one camera having at least one field of view covering at least one monitored area in proximity to the one or more installed utility infrastructure components;
analyzing the image data to determine whether an event related to an installed infrastructure component of the one or more installed utility infrastructure components is occurring or has occurred in the at least one monitored area; and
when an event is detected, communicating an alert to a remote computing device to facilitate presentation of an alert notification to an operator of the one or more installed infrastructure components.
